(19) United States
(12) Patent Application Publication
(10) Pub. No.: US 2006/0108786 A1
(43) Pub. Date: May 25, 2006

(54) Tongue retrieval system and a seatbelt apparatus

(75) Inventors: Tadashi Sugiyama, Hikone-shi (JP); Masashi Nanbu, Hikone-shi (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/265,518

(22) Filed: Nov. 3, 2005

(30) Foreign Application Priority Data
Nov. 5, 2004 (JP) 2004-322218

(51) Int. Cl. B60R 22/00; B60R 22/12

(52) U.S. Cl. 280/801.1; 297/468

(57) ABSTRACT

A tongue retrieval system is configured to automatically transfer a tongue receiving member and, therefore, a tongue to a tongue retrieval position from a tongue storing position. The tongue receiving member is transferred from the tongue storing position to the tongue retrieval position when a rod is extended on the basis of a seating signal from a seating sensor and a door-close signal from a door sensor. The tongue receiving member is returned to the tongue storing position when the rod is retracted on the basis of a tongue retrieval signal from a tongue retrieval sensor or a tongue engagement signal from the buckle switch. The tongue retrieval system also improves the ease by which the tongue is handled and the likelihood that the tongue will be successfully retrieved.

### BACKGROUND

The present invention relates to a seatbelt apparatus, which is installed in a motor vehicle (e.g., an automobile) and which fastens and protects an occupant by a seatbelt.

More specifically, the invention relates to a tongue retrieval system to assist the occupant in retrieving a tongue, which is supported by the seatbelt and which is configured to engage a buckle fixed to a body of a vehicle, or the like. Additionally, the invention also relates to a seatbelt apparatus using the tongue retrieval system.

A seatbelt apparatus, which is attached to a seat of a motor vehicle (e.g., an automobile or the like), is conventionally provided to protect an occupant. The seatbelt apparatus fastens an occupant with a seatbelt so as to prevent the occupant from exiting the seat in an emergency situation (e.g., due to great deceleration applied to the motor vehicle because of a collision or the like).

FIG. 13 shows a conventional three-point-type seatbelt apparatus 1 that is installed in a motor vehicle seat 2. Reference numeral 3 denotes a seatbelt retractor 3, which is fixed to a body of a vehicle adjacent to the motor vehicle seat 2. Under normal conditions, the retractor 3 serves to retract the seatbelt 4 and to allow the seatbelt 4 to be withdrawn. In contrast, in emergency situations (e.g., due to a collision or the like), the retractor 3 substantially prevents the seatbelt 4 from being withdrawn. Reference numeral 5 denotes a tongue, which is slidably supported by the seatbelt 4. Reference numeral 6 denotes a buckle, which is fixed to the motor vehicle seat 2 or the vehicle body and which is configured to engage the tongue 5. Reference numeral 7 denotes a belt guide, which is attached to an upper part of a side portion of the motor vehicle (e.g., a center pillar 8 or the like) and which guides the seatbelt 4 withdrawn from the seatbelt retractor 3. In addition, a belt anchor portion 4a of the tip end of the seatbelt 4 withdrawn from the seatbelt retractor 3 is fixed to the motor vehicle seat 2 or the vehicle body.

In the conventional seatbelt apparatus 1, when the occupant is seated on the motor vehicle seat 2, the occupant withdraws the seatbelt 4 from the seatbelt retractor 3 by grabbing and pulling the tongue 5. The occupant then engages the tongue 5 with the buckle 6 and releases the tongue 5. Any excessively withdrawn seatbelt 4 is then retracted by the seatbelt retractor 3 such that any slack of the seatbelt 4 is eliminated, thereby fastening the occupant in the seat 2.

When a seated occupant does not engage the tongue 5 and the buckle 6, the seatbelt 4 is completely retracted by the seatbelt retractor 3. As a result, the seatbelt 4 is positioned between the belt guide 7 (which is attached to, for example, the center pillar 8) and the belt anchor portion 4a (which is positioned is the vicinity of the center pillar 8). Therefore, the tongue 5, which is supported by the seatbelt 4, is positioned adjacent to the center pillar 8.

When the tongue 5 is positioned adjacent the center pillar 8 and when an occupant is seated on the motor vehicle seat 2, the tongue 5 is positioned at a side of, and typically behind the occupant. As a result, when the seated occupant tries to grab the tongue 5 (to wear the seatbelt 4), the occupant must turn to look behind himself/herself and is, therefore, forced to grab the tongue 5 in an unstable posture. Consequently, the tongue 5 is problematically difficult to retrieve such that a handling operation for the tongue 5 (to engage with the buckle 6) is problematically complicated and bothersome.

In consideration of these problems, an alternate seatbelt apparatus is proposed in, for example, laid open Japanese Registered Utility Model No. 61-176047, which is incorporated herein by reference in its entirety. The seatbelt apparatus disclosed in Japanese Registered Utility Model No. 61-176047 includes: (a) a retractable telescopic-type rod; (b) a belt hanger portion that is formed such that a webbing is loosely fit to a tip end of the rod; and (c) a motor to retract the rod. Further, when a driver enters the motor vehicle, closes the door, and turns on an ignition switch, the rod is extended by a rotation of the motor, thereby forwardly protruding the belt hanger portion. As a result, the seatbelt, which is loosely fit at the belt hanger portion, is also advanced forward. Correspondingly, the tongue, which is supported by the seatbelt, is thereby guided toward a position within a reach of the occupant. When the occupant grabs the tongue and inserts the tongue into a buckle (or even when the occupant does not grab the tongue), the motor is subsequently (after a predetermined period of time) rotated in a reverse direction and the rod is retracted.

However, in the seatbelt apparatus disclosed in Japanese Registered Utility Model No. 61-176047, because the seatbelt is only advanced by forwardly protruding the belt hanger portion, the tongue does not always reach the position at which it may be easily retrieved by an occupant. Accordingly, when the seatbelt is not worn by the occupant, the ease by which the tongue is handled is insufficiently performed and, therefore, assured retrieval operation for the tongue is not achieved. Consequently, it is difficult to easily wear the seatbelt.

Further, as the rod only extends when a driver turns on an ignition switch after closing a door, a passenger who enters the car before the driver will not cause the rod to extend. Therefore, the passenger's seatbelt will not advance to a position in front of the passenger, without the driver entering the vehicle and starting the ignition. Consequently, the ease by which the tongue is handle is insufficiently and, therefore, an assured retrieval operation for the tongue is not achieved, thereby further preventing an ability to easily wear the seatbelt.

Furthermore, when the rod is retracted after the occupant inserts and engages the tongue with the buckle, as the belt hanger portion remains in front of the occupant, the seatbelt is not set at a comfortable position for the occupant. Moreover, as the rod is automatically retracted when a predetermined time has elapsed (after the belt hanger portion is forwardly protruded), if the occupant delays retrieving the tongue (e.g., due to a delay in being seated or the like), the seatbelt moves backward before the occupant has a chance to retrieve the tongue, thereby problematically returning the tongue to the original position behind the occupant. Consequently, the ease by which the tongue is handled is insufficient and, therefore, an assured retrieval operation for the tongue is not achieved As a result, the seatbelt cannot be easily worn.

Furthermore, when the rod is extended and the belt hanger portion is protruded forward, the extended rod is adjacent the occupant. As a result, the occupant may inadvertently contact the rod and transfer a relatively large (possibly damaging) force thereto.

Accordingly, the present invention has been made in light of the aforementioned problems. Various objects of the invention include: (a) providing a tongue retrieval system that is capable of automatically transferring a tongue receiving member between a tongue retrieval position and a storing position, to convey the tongue to the tongue retrieval position; and (b) improving the ease by which the tongue is handled and the assuredness of the retrieval operation of the tongue performed by the occupant. Another object of the present invention is to provide a seatbelt apparatus that facilitates easily wearing the seatbelt by simplifying the handling operation of the tongue, thereby assuring that the tongue is retrieved by the passenger or driver (which, unless otherwise indicated, are hereafter collectively referred to as an “occupant”).

### SUMMARY

An embodiment of the present invention addresses a tongue retrieval system for conveying a tongue that is slidably supported by a seatbelt to a tongue retrieval position, which is in front of an occupant seated on a motor vehicle seat. This system includes, among other possible things: (a) a tongue receiving member on which the tongue is mounted for conveying the tongue to the tongue retrieval position; (b) a transfer device for transferring the tongue receiving member between a tongue storing position and the tongue retrieval position; (c) a transfer device driver for driving the transfer device; (d) a controller for controlling the transfer device driver; (e) a seating sensor for detecting that the occupant is seated on the motor vehicle seat and for outputting a seating signal; (f) a door sensor for outputting a door-close signal when a door adjacent the seat of the motor vehicle is closed; and (g) a tongue retrieval sensor for outputting a tongue retrieval signal when the tongue is retrieved from the tongue receiving member. The controller is configured to control the transfer device driver such that the transfer device transfers the tongue from: (i) the tongue storing position to the tongue retrieval position on a basis of the seating signal from the seating sensor and the door-close signal from the door sensor; and (ii) the tongue retrieval position to the tongue storing position on the basis of the tongue retrieval signal from the tongue retrieval sensor.

Another embodiment of the present invention addresses a tongue retrieval system for conveying a tongue that is slidably supported by a seatbelt to a tongue retrieval position, which is in front of an occupant seated on a motor vehicle seat. This system includes, among other possible things: (a) a tongue receiving member on which the tongue is mounted for conveying the tongue to the tongue retrieval position; (b) a transfer device for transferring the tongue receiving member between a tongue storing position and the tongue retrieval position; (c) a transfer device driver for driving the transfer device; (d) a controller for controlling the transfer device driver; (e) a seating sensor for detecting that the occupant is seated on the motor vehicle seat and for outputting a seating signal; (f) a door sensor for outputting a door-close signal when a door adjacent the seat of the motor vehicle is closed; (g) a buckle, which is mounted on the motor vehicle and which is configured to engage the tongue; and (h) a buckle switch for outputting a tongue engagement signal when the tongue is engaged with a buckle. The controller is configured to control the transfer device driver such that the transfer device transfers the tongue from: (i) the tongue storing position to the tongue retrieval position on a basis of the seating signal from the seating sensor and the door-close signal from the door sensor; and (ii) the tongue retrieval position to the tongue storing position on the basis of the tongue engagement signal from the buckle switch.

Another embodiment of the present invention addresses a seatbelt apparatus that includes, among other possible things: (a) a seatbelt for restraining an occupant in a motor vehicle seat; (b) a seatbelt retractor mounted on the motor vehicle for constantly urging the seatbelt in a retracting direction; (c) a tongue that is slidably supported by the seatbelt; (d) a buckle, which is mounted on the motor vehicle and which is configured to engage the tongue; and (e) a tongue retrieval system for conveying the tongue to a tongue retrieval position, which is in front of the occupant seated on the motor vehicle seat. The tongue retrieval system of the seatbelt apparatus includes, among other possible things: (i) a tongue receiving member on which the tongue is mounted for conveying the tongue to the tongue retrieval position; (ii) a transfer device for transferring the tongue receiving member between a tongue storing position and the tongue retrieval position; (iii) a transfer device driver for driving the transfer device; (iv) a controller for controlling the transfer device driver; (v) a seating sensor for detecting that the occupant is seated on the motor vehicle seat and for outputting a seating signal; (vi) a door sensor for outputting a door-close signal when a door adjacent the seat of the motor vehicle is closed; and (vii) a tongue retrieval sensor for outputting a tongue retrieval signal when the tongue is retrieved from the tongue receiving member. The controller is configured to control the transfer device driver such that the transfer device transfers the tongue from: (A) the tongue storing position to the tongue retrieval position on a basis of the seating signal from the seating sensor and the door-close signal from the door sensor; and (B) the tongue retrieval position to the tongue storing position on the basis of the tongue retrieval signal from the tongue retrieval sensor.

In a further embodiment of this seatbelt apparatus, the seatbelt apparatus may additionally include, among other possible things: (f) a buckle transfer device for transferring the buckle between a buckle storing position and a buckle using position in which the buckle is engaged with the tongue by the occupant; (g) a buckle driver for driving the buckle transfer device; and (h) a controller for controlling the buckle driver such that the buckle is transferred from the buckle storing position to the buckle using position in conjunction with the driving operation of the transfer device driver.

In another further embodiment of this seatbelt apparatus, the buckle may be configured to move from the buckle storing position to the buckle using position along an arcuate path or a linear path.

Another embodiment of the present invention addresses a seatbelt apparatus that includes, among other possible things: (a) a seatbelt for restraining an occupant in a motor vehicle seat; (b) a seatbelt retractor mounted on the motor vehicle for constantly urging the seatbelt in a retracting direction; (c) a tongue that is slidably supported by the seatbelt; (d) a buckle, which is mounted on the motor vehicle and which is configured to engage the tongue; and (e) a tongue retrieval system for conveying the tongue to a tongue retrieval position, which is in front of the occupant seated on the motor vehicle seat. The tongue retrieval system of the seatbelt apparatus includes, among other possible things: (i) a tongue receiving member on which the tongue is mounted for conveying the tongue to the tongue retrieval position; (ii) a transfer device for transferring the tongue receiving member between a tongue storing position and the tongue retrieval position; (iii) a transfer device driver for driving the transfer device; (iv) a controller for controlling the transfer device driver; (v) a seating sensor for detecting that the occupant is seated on the motor vehicle seat and for outputting a seating signal; (vi) a door sensor for outputting a door-close signal when a door adjacent the seat of the motor vehicle is closed; and

(vii) a buckle switch for outputting a tongue engagement signal when the tongue is engaged with the buckle. The controller is configured to control the transfer device driver such that the transfer device transfers the tongue from: (A) the tongue storing position to the tongue retrieval position on a basis of the seating signal from the seating sensor and the door-close signal from the door sensor; and (B) the tongue retrieval position to the tongue storing position on the basis of the tongue engagement signal from the buckle switch.

In a further embodiment of this seatbelt apparatus, the seatbelt apparatus may additionally include, among other possible things: (f) a buckle transfer device for transferring the buckle between a buckle storing position and a buckle using position in which the buckle is engaged with the tongue by the occupant; (g) a buckle driver for driving the buckle transfer device; and (h) a controller for controlling the buckle driver such that the buckle is transferred from the buckle storing position to the buckle using position in conjunction with the driving operation of the transfer device driver.

In another further embodiment of this seatbelt apparatus, the buckle may be configured to move from the buckle storing position to the buckle using position along an arcuate path or a linear path.

Another embodiment of the present invention addresses a system for conveying a tongue that is slidably supported by a seatbelt to a retrieval position in front of an occupant seated on a motor vehicle seat. This system includes, among other possible things: (a) a tongue receiving member on which the tongue is mounted; (b) a driven transfer device for transferring the tongue receiving member between a storage position and the retrieval position; (c) a first sensor for detecting that the occupant is seated on the seat; (d) a second sensor for detecting when a door adjacent the seat is closed; (e) a third sensor for detecting when the tongue is retrieved from the tongue receiving member; and (f) a controller configured to control the movement of the transfer device from the storage position to the retrieval position based on input from the first and second sensors, and from the retrieval position to the storage position based on input from the third sensor.

In the aforementioned tongue retrieval systems, in which the tongue is mounted on a tongue receiving member to be conveyed to a tongue retrieval position for wearing a seatbelt, an occupant seated on the motor vehicle seat can easily grab the tongue. Therefore, the occupant's ease of handling the tongue is improved and the tongue may be readily and assuredly retrieved.

Further, even when a passenger enters the motor vehicle before the driver, the tongue receiving member can be set to the tongue retrieval position and the tongue can be assuredly conveyed to the tongue retrieval position. Accordingly, in comparison with Japanese Registered Utility Model No. 61-176047, the passenger's ease of handling the tongue is improved and the likelihood that the passenger will retrieve the tongue is also improved.

Furthermore, because the transfer device starts operating on the basis of two signals (i.e., the door-close signal from the door sensor and the seating signal from the seating sensor), the operation of the transfer device can be started only when the occupant is seated on the motor vehicle seat and the door is closed. Thereby, when the door is opened and closed by an occupant who is not seated on the motor vehicle seat, the transfer device is prevented from extending. Similarly, when an occupant who is seated on the motor vehicle seat, changes his/her seating posture (e.g., reclining, slouching, reaching for a control button, etc.) while the door is closed, the transfer device is also prevented from extending, thereby preventing a needless operation of the transfer device.

According to the tongue retrieval system of the present invention, after the occupant grabs the tongue from the tongue receiving member, the tongue receiving member may be positioned at the storing position (or adjacent to the storing position) when the tongue is inserted and engaged with a buckle. Accordingly, when the occupant releases the tongue (after engaging the tongue with the buckle), the seatbelt can be properly adjusted to tighten the occupant, thereby preventing the occupant from sensing any discomfort.

Moreover, the tongue receiving member cannot be transferred to the storing position behind the motor vehicle seat unless the occupant grabs the tongue from the tongue receiving member. As a result, because the occupant is not required to quickly grab the tongue from the tongue receiving member (after being seated in the motor vehicle seat), the ease of handling the tongue by the occupant is further improved and the retrieving operation may be assuredly performed.

As the seatbelt can be easily handled and the tongue can be assuredly retrieved by applying the tongue retrieval system, the seatbelt can be easily worn. Furthermore, in those embodiments in which the buckle is transferred from the buckle storing position to the buckle using position (in conjunction with the transferring operation for the tongue receiving member), neither the tongue retrieval device nor the buckle disturbs the occupant when the seatbelt is not used. Moreover, if the occupant desires to use the seatbelt, the occupant can easily insert the tongue into the buckle and engage the tongue with the buckle.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIGS. 1A-1C are schematic views that illustrate an embodiment of a tongue retrieval assisting device used in an embodiment of a tongue retrieval system according to the present invention, in which FIG. 1A shows a motor vehicle seat when viewed from the left, FIG. 1B shows the motor vehicle seat of FIG. 1A when viewed from front, and FIG. 1C shows the motor vehicle seat of FIGS. 1A and 1B when viewed from below;

FIGS. 2A and 2B are enlarged illustrations that show the tongue retrieval assisting device of the embodiment shown in FIGS. 1A-1C, when viewed from the left, in which FIG. 2A shows a rod in a state of being retracted, and FIG. 2B shows the rod in a state of being extended;

FIG. 3A is an illustration that shows a tongue receiving portion in a state of being attached to the rod of the embodiment shown in FIGS. 1A-1C; FIG. 3B is a plan view that shows the tongue receiving portion; FIG. 3C is a side view that shows the tongue receiving portion; and FIG. 3D shows the tongue engagement portion;

FIG. 4 is a perspective view that illustrates a rod attached by rubber-mounts;

FIG. 5 is a view that explains a process by which a tongue receiving plate receives the tongue;

FIG. 6 is a flowchart that explains a motor control of the tongue retrieval system according to an embodiment of the present invention;

FIG. 7 is a flowchart that explains a motor control of the tongue retrieval system according to another embodiment of the present invention;

FIG. 8 is a perspective view that partially shows a tongue retrieval assisting device according to another embodiment of the present invention;

FIG. 9 is a perspective view that shows a tongue receiving portion of the embodiment shown in FIG. 8;

FIG. 10A is an illustration that shows a state in which a gripping portion of the tongue is mounted on the tongue receiving portion of the embodiment shown in FIG. 9; and FIG. 10B shows an enlarged view of a gripping portion of FIG. 10A engaged with a tongue receiving plate;

FIGS. 11A and 11B are illustrations that show still another embodiment of the present invention, in which FIG. 11A shows a buckle in a storing position and FIG. 11B shows the buckle in a using position;

FIGS. 12A and 12B are illustrations that show still another embodiment of the present invention, in which FIG. 12A shows a buckle in a storing position, and FIG. 12B shows the buckle in a using position; and

FIG. 13 is an illustration that shows a conventional three-point-type seatbelt apparatus.

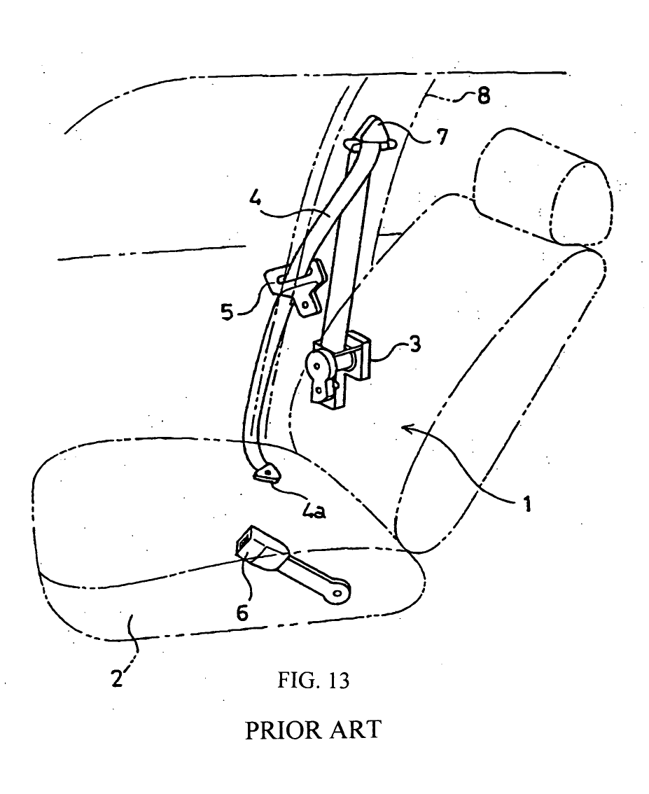

### DETAILED DESCRIPTION

Embodiments of the present invention will be described with reference to the drawings. Like numbers are used throughout the drawings to refer to the same or similar parts in each of the embodiments of the invention described herein.

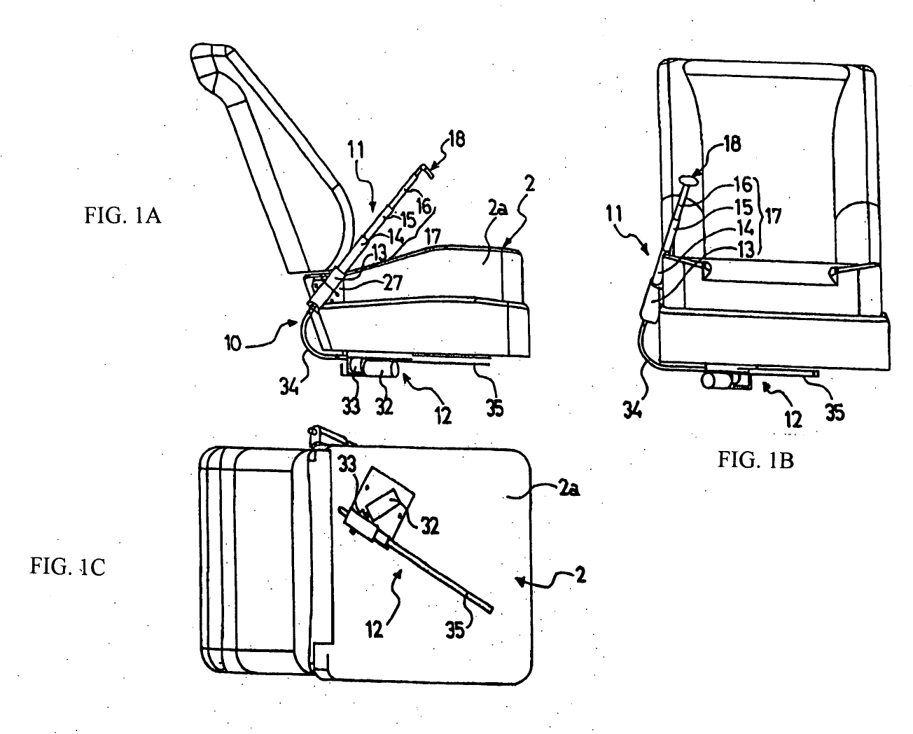

FIGS. 1A-1C schematically illustrate an embodiment of a tongue retrieval assisting device 10 used in an embodiment of a tongue retrieval system with respect to the present invention. As illustrated in FIGS. 1A-1C, the tongue retrieval assisting device 10 in this embodiment is provided with a tongue conveying section 11 and a drive section 12 that operates the tongue conveying section 11. The tongue conveying section, which is disposed in the shown embodiment at the left side of the motor vehicle seat 2, conveys a tongue 5 to a tongue retrieval position.

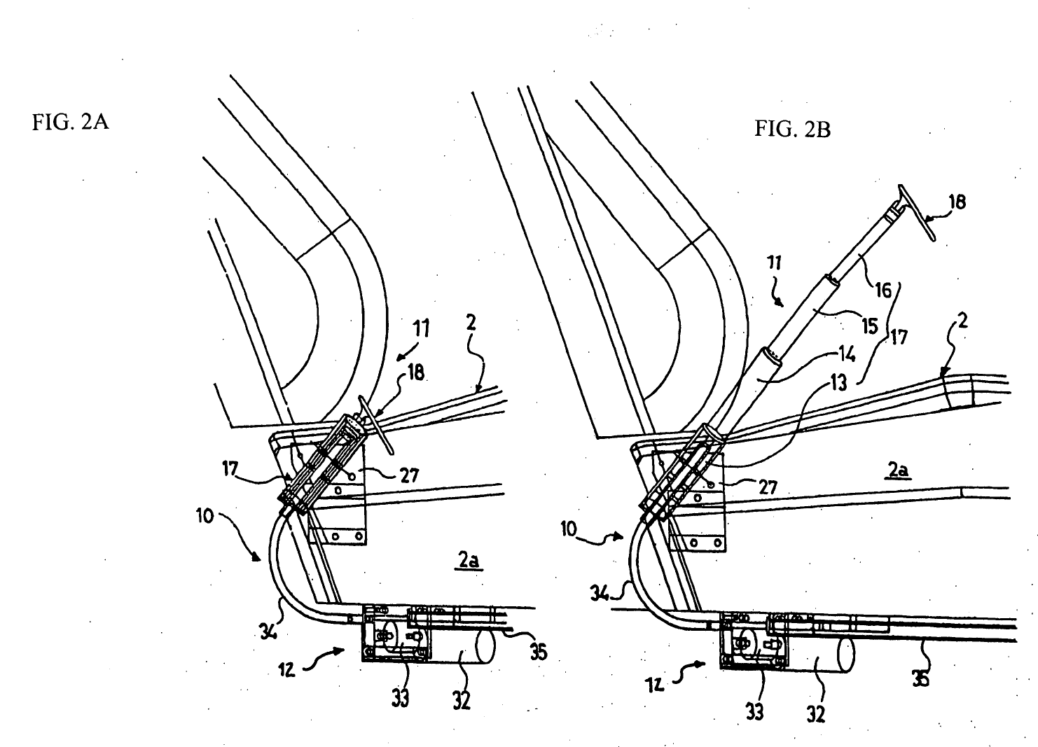

As illustrated in FIGS. 2A and 2B, the tongue conveying section 11 is provided with a transfer device in the form of a rod 17, that is retractably composed of four cylindrical rod members 13-16 in a telescopic structure. The tongue conveying section 11 is also provided with a tongue receiving member 18 that is provided at a tip end the rod member 16 that has the smallest diameter of the four cylindrical rod members 13-16.

As for the telescopic structure of the rod 17 (which is composed of the four cylindrical rods 13-16), a conventional structure can be used and, therefore, an explanation thereof is omitted. Further, the number of telescoping rod members is not limited to four and instead may be appropriately determined based on the particular vehicle in which the tongue retrieval system is to be employed.

The rod 17 moves between a retracted state (FIG. 2A) and an extended state (FIG. 2B). In the retracted state of the rod 17, the tongue receiving member 18 is positioned at a storing position at the left side generally behind the motor vehicle seat 2; in this storing position, the tongue receiving member 18 and the rod 17 do not meaningfully disturb an occupant who is getting into or out of the motor vehicle. Further, in the extended state of the rod 17, the tongue receiving member 18 is positioned in a slightly inner side of the motor vehicle seat 2, as illustrated in FIG. 1B. The tongue receiving member 18 in the extended state of the rod 17 is generally positioned in front of the chest or the waist of an occupant who is seated on the motor vehicle seat 2, thereby enabling the occupant to easily grab the tongue 5 mounted on the tongue receiving member 18 at a tongue retrieval position 5″.

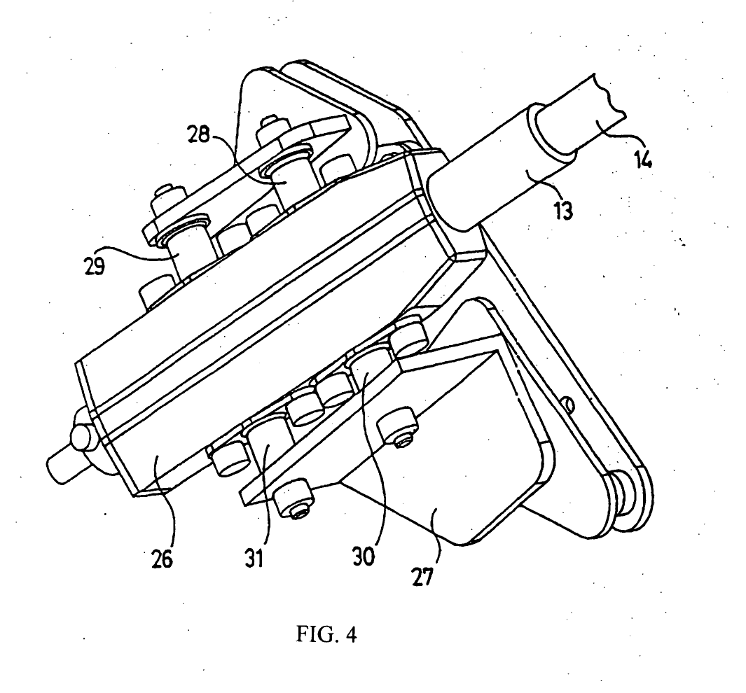

As illustrated in FIG. 4, the rod member 13, which has the largest diameter among the rod members 13-16, is attached to an attaching bracket 26. The attaching bracket 26 is elastically attached to an attaching bracket 27 of the motor vehicle seat 2 through four rubber-mounts 28-31. The attaching bracket 27 is attached to the left side of the rear part of the motor vehicle seat 2, as illustrated in FIGS. 1A, 2A and 2B. The attaching brackets 26, 27 are attached to the motor vehicle seat 2, such that when the rod 17 is extended, the tongue receiving member 18 comes to the tongue retrieval position 5″.

As the rod 17 is elastically supported by the four rubber-mounts 28-31, any force applied to the rod 17, the tongue receiving member 18, and/or the attaching portion 21 of the rod 17 is buffered. As a result, relatively large forces do not meaningfully affect these elements 17, 18, 21, even when the occupant contacts the rod 17 (or the tongue receiving member 18 when the rod 17 is extended). In other words, even when force is applied to the rod 17 or the tongue receiving member 18 from any direction, the force is substantially buffered by the four rubber-mounts 28-31.

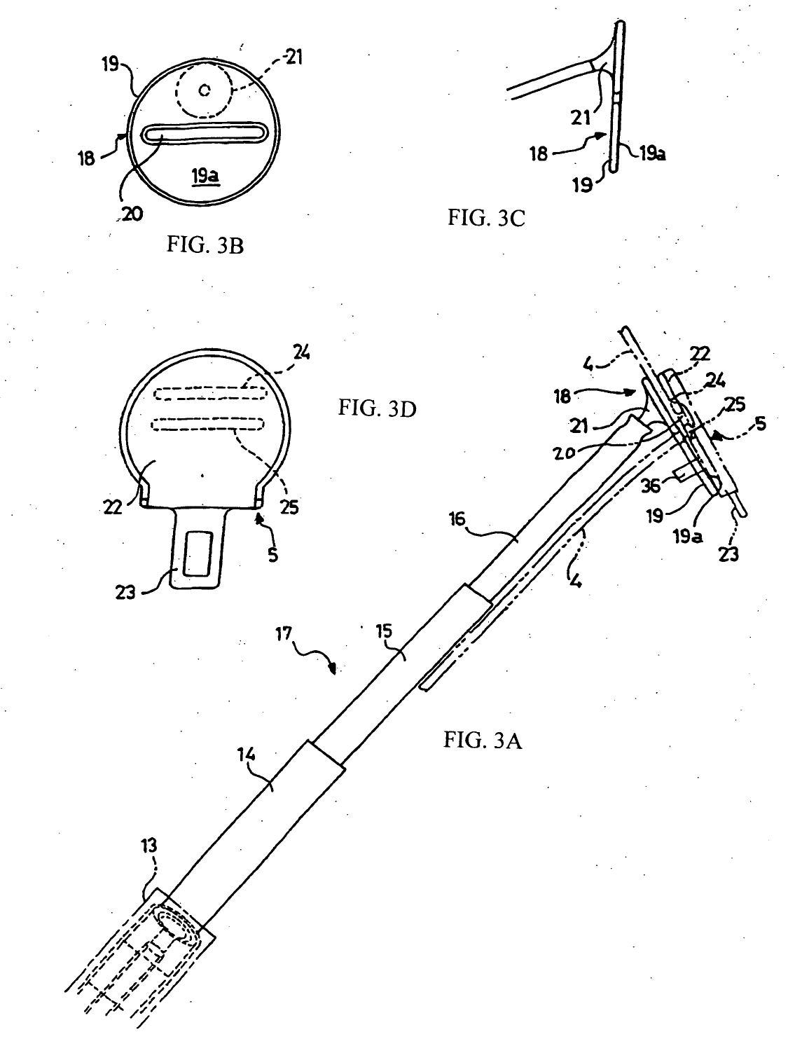

As magnified in FIGS. 3A-3C, the tongue receiving member 18 includes a tongue receiving plate 19 that has a shape of an approximately circular disc. The tongue 5, which is mounted on a tongue receiving face 19a of the tongue receiving plate 19, is conveyed thereby to the tongue retrieval position 5″. At a center of the tongue receiving plate 19 is an elongated penetration hole 20 that extends in a radial direction; a seatbelt 4 is slidably received in the penetration hole 20. At a face opposite to the tongue receiving face 19a of the tongue receiving plate 19, an attaching portion 21 is provided at an eccentric position in the face. The attaching portion 21 is attached to a tip end of the rod member 16 that has the smallest diameter among the four rod members 13-16. In this case, the tongue receiving plate 19 is configured to extend downward from the attaching portion 21.

The tongue 5, which is mounted on the tongue receiving plate 19, is composed of a gripping portion 22 to be gripped by an occupant's hand. The griping portion 22 is an arc-shaped plate that has a diameter that is slightly larger than that of the tongue receiving plate 19. The gripping portion 22 also has an engagement portion 23 that projects from the gripping portion 22 and that is configured to be inserted into and engaged with the buckle 6. A pair of parallel holes 24 and 25 are positioned in the gripping portion 22. The holes 24, 25 form a link with each other at an end of the gripping portion 22 opposite the engagement portion 23. The seatbelt 4, which is lowered from a belt guide 7, is slidably inserted into the hole 24 formed at a position farther from the engagement portion 23 and is slidably withdrawn from the elongated hole 25 formed at a position closer to the engagement portion 23, thereby enabling an occupant to adjust the position of the tongue 5 on the seatbelt 4.

As illustrated in FIG. 3A by a two-dot chain line, the tongue 5 is mounted on the tongue receiving plate 19 at the gripping portion 22 such that the engagement portion 23 is directed downward. At this time, part of the gripping portion 22 between the pair of holes 24, 25, which is closer to the elongated hole 25 is pressed to the tongue receiving plate 19 by a belt retracting force caused by a seatbelt retractor 3. As a result, the gripping portion 22 is stably mounted to the tongue receiving plate. In addition, because the tongue receiving plate 19 has a relatively wide flat face, the mounting operation of the tongue 5 onto the tongue receiving member 18 is made stable.

As the diameter of the tongue receiving plate 19 is slightly smaller than the diameter of the gripping portion 22 of the tongue 5, the outer dimension of the tongue receiving plate 19 is smaller than that of the gripping portion 22. As a result, when the gripping portion 22 of the tongue 5 is mounted on the tongue receiving plate 19, a peripheral edge of the gripping portion 22 of the tongue 5 protrudes outward from that of the tongue receiving plate 19. Thereby, when the occupant grips the gripping portion 22 of the tongue 5, the likelihood that the tongue receiving plate 19 is also gripped is small.

As illustrated in FIGS. 1A-1C, 2A, and 2B, the drive section 12 is provided at a lower part of the motor vehicle seat 2. The drive section 12 is provided with a motor 32, which is attached to a lower part of the seat cushion 2a in the motor vehicle seat 2. The drive section 12 also includes: (a) a drive gear 33 to which rotation drive force of the motor 32 is transmitted with reduced speed; (b) a flexible rod extension/retraction cable 34, which is connected to the rod member 16 that has the smallest diameter of the rod members 13-16 (by internally passing through each of the rod members 13-16), and which has teeth (not shown) that constantly engage the drive gear 33; and (c) a cable guide 35 for guiding the rod extension/retraction cable 34, which guide 35 is extendably provided (on a lower face of the seat cushion 2a of the motor vehicle seat 2) in a slanting manner from a left side of a rear part of the seat 2 to a right side of a front part of the seat 2. A conventional power transmission structure can be used for the power transmission structure in which the rotation drive force of the motor 32 is applied to the rod extension/retraction cable 34 and, therefore, an explanation thereof omitted.

When the motor 32 is rotated in a direction in which the rod extension/retraction cable 34 is driven toward the rod 17, the rod 17 is telescopically extended. On the contrary, when the motor 32 is rotated in an opposite direction in which the rod extension/retraction cable 34 is retracted toward the cable guide 35, rod 17 is telescopically retracted.

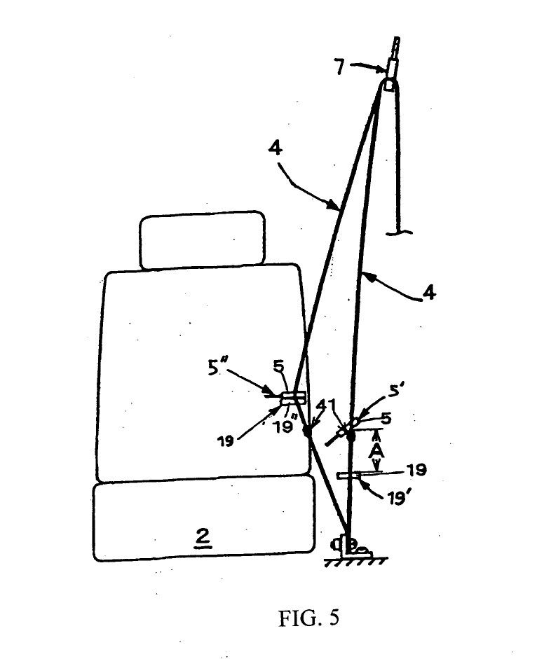

As illustrated in FIG. 5, when the seatbelt 4 is not worn, the tongue 5 is stopped by a tongue stopper 41 in a tongue storing position 5′, i.e., the tongue 5 is not lowered further, similar to the case in the heretofore known seatbelt apparatus. Further, when the tongue retrieval assisting device 10 is not in operation, the tongue receiving plate 19 is maintained at a plate storing position 19′. In this condition, a distance A between the position of the tongue storing position 5′ when the seatbelt 4 is not worn and the plate storing position 19′ is smaller than the extending amount of the rod 17, namely, the distance between the plate storing position 19′ and the tongue retrieval position 5″. Thereby, when the rod 17 is extended together with the operation of the tongue retrieval assisting device 10, the tongue 5 can be assuredly received by the tongue receiving plate 19. In this case, the penetration hole 20 of the tongue receiving plate 19 is sized such that the tongue stopper 41 is able to smoothly pass through the penetration hole 20 when the rod 17 is extended. Consequently, when the rod 17 is extended so that the tongue receiving member 18 is transferred from the plate storing position 19′ to the tongue retrieval position 5″, the tongue receiving plate 19 of the tongue receiving member 18 conveys the tongue 5 mounted thereupon to the tongue retrieval position 5″.

Thus, in accordance with the tongue retrieval assisting device 10 of this embodiment, when the tongue receiving member 18 is transferred from the plate storing position 19′ to the tongue retrieval position 5″, the tongue 5 is conveyed to the tongue retrieval position 5″ by the tongue receiving member 18. As a result, an occupant seated on the motor vehicle seat 2 can easily grab the tongue 5. Therefore, when the occupant wants to wear the seatbelt 4, the ease of handling the tongue 5 is greatly improved, thereby assuring that the tongue 5 can be retrieved.

Further, when a passenger, who is seated in the motor vehicle seat 2 before the driver enters the vehicle, tries to wear the seatbelt 4, the tongue 5 can be assuredly conveyed to the tongue retrieval position 5″ by the tongue receiving member 18. Accordingly, in comparison with the case described in Japanese Registered Utility Model No. 61-176047, the operational ease of handling the tongue 5 by the passenger is greatly improved and the assuredness of the passenger's retrieving the tongue is also greatly improved.

As the outer shape of the tongue receiving plate 19 of the tongue receiving member 18 is smaller than that of the gripping portion 22 of the tongue 5, the peripheral edge of the gripping portion 22 of the tongue 5 outwardly projects from the peripheral edge of the tongue receiving plate 19 when the gripping portion 22 of the tongue 5 is mounted on the tongue receiving plate 19. As a result, the occupant can easily grip the gripping portion 22, without also gripping the tongue receiving plate 19. Accordingly, the tongue 5 can be further easily and assuredly retrieved.

As the tongue retrieval assisting device 10 is attached to the motor vehicle seat 2, even when the position of the motor vehicle seat 2 is adjusted in a back-and-front direction by the occupant, the tongue retrieval assisting device 10 is correspondingly moved. Therefore, the tongue retrieval position 5″ relative to the motor vehicle seat 2 is unchanged and, therefore, the tongue retrieval position 5″ relative to the occupant seated on the motor vehicle seat 2 is approximately constant.

By applying the tongue retrieval assisting device 10 of this embodiment to the seatbelt apparatus, the ease of inserting and engaging the tongue 5 with the buckle 6 is improved, thereby enhancing the likelihood that the occupant will wear the seatbelt 4.

In the tongue retrieval assisting device 10 of this embodiment, the tongue retrieval system is configured such that the tongue receiving member 18 is automatically set to the tongue retrieval position 5″ and the plate storing position 19′ by extending or retracting the rod 17 (by controlling the rotation of the motor 32 with an electronic controller (not shown)).

In the tongue retrieval system of this embodiment, a tongue retrieval sensor 36, which detects when the occupant has retrieved the tongue 5 from the tongue receiving member 18 and which outputs a tongue retrieval signal, may be provided in the tongue receiving member 18, as illustrated in FIG. 3A. Further, a conventional seating sensor (not shown) for detecting whether the occupant is seated on the motor vehicle seat 2 may be provided in the motor vehicle seat 2. Similarly, a conventional door sensor (not shown) for detecting an opening or closing of the door may be provided in the door. In addition, as the rod 17 moves between a fully extended position (in which the tongue receiving member 18 is at the tongue retrieval position 5″) and a retracted positioning (in which the tongue receiving member 18 is at the plate storing position 19′), conventional rod extension and retraction sensors may be provided in (or adjacent) the rod 17.

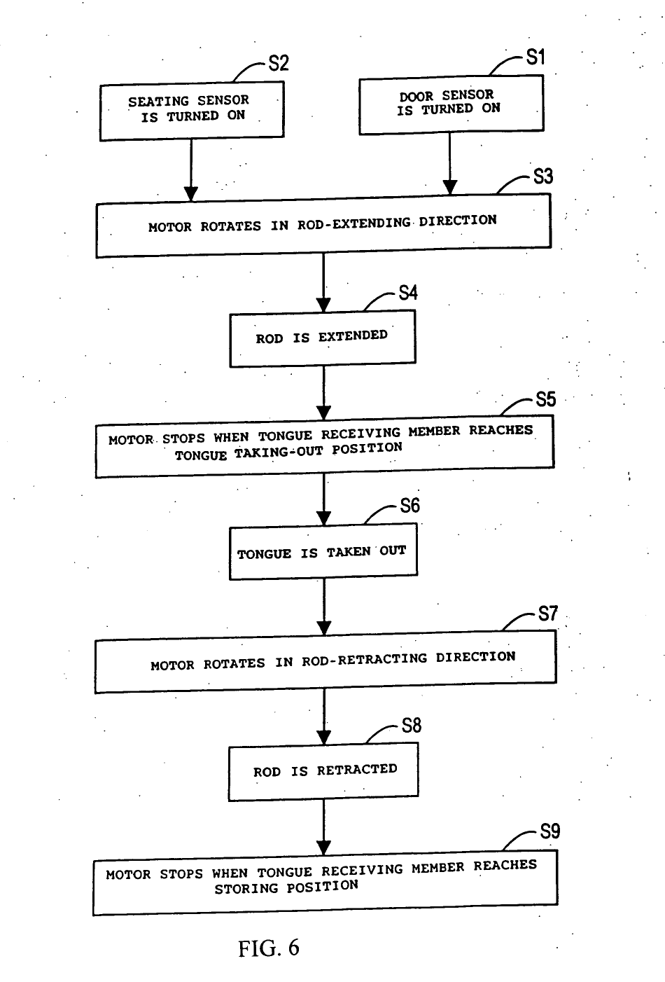

In the tongue retrieval system of this embodiment, the tongue receiving member 18 may be automatically set at the tongue. retrieval position 5″ or the plate storing position 19′ by the controller of the motor 32, as shown in FIG. 6. Specifically, in response to a door closing signal (from the door sensor) that indicates that the door is closed (Step S1) and a seating signal (from the seating sensor) that indicates that the occupant is seated (Step S2), the controller instructs the motor 32 to rotate in a direction in which the rod 17 is extended (Step S3). When the rod 17 is fully extended such that the tongue receiving member 18 reaches the tongue retrieval position 5″, as indicated by a full extension signal (from the rod full extension sensor), the motor 32 is stopped by the controller (Steps S4, S5). When the tongue 5, which is conveyed to the tongue retrieval position 5″ by the tongue receiving member 18, is retrieved by the occupant, as determined on the basis of the tongue retrieval signal (from the tongue retrieval sensor 36), the controller instructs the motor 32 to rotate in a reverse direction, i.e., in a direction in which the rod 17 is retracted (Steps S6, S7). Finally, when the rod 17 is fully retracted such that the tongue receiving member 18 reaches the plate storing position 19′, as indicated by a full retraction signal (from the rod retraction extension sensor), the motor 32 is stopped by the controller (Steps S8, S9).

According to the tongue retrieval system of this embodiment, the rod 17 is retracted when the tongue 5 is retrieved from the tongue receiving member 18 by the occupant. Therefore, at a time when the tongue is inserted and engaged with the buckle 6, the rod 17 is retracted and the tongue receiving member 18 is positioned at the plate storing position 19′ or a position adjacent to the plate storing position 19′. Accordingly as the rod 17 is automatically retracted after removing the tongue 5 from the tongue receiving member 18, when the occupant releases the tongue 5 (after engaging the tongue 5 with the buckle 6), the seatbelt 4 can be adjusted (to properly tighten the occupant) without the rod 17 unnecessarily interfering, thereby preventing the occupant from sensing discomfort.

Moreover, unless the occupant removes the tongue 5 from the tongue receiving member 18, the tongue receiving member 18 is not returned to the plate storing position 19′ behind the motor vehicle seat 2. By the aforementioned configuration, the occupant's ease of handling the tongue 5 is further improved and the assuredness of the occupant's retrieval of the tongue 5 is also improved.

Furthermore, because the rod 17 starts to extend on the basis of the door-close signal from the door sensor and the seating signal from the seating sensor, the rod 17 can start to extend only when the occupant is seated on the motor vehicle seat 2 and the door is closed. Thereby, even when the door is opened and closed while the occupant is not seated on the motor vehicle seat 2, the rod 17 is prevented from being extended. Similarly, when an occupant, who is already seated on the motor vehicle seat 2, changes his/her seating posture, while the door is closed, the rod 17 is also prevented from extending, thereby preventing a needless extension of the rod 17.

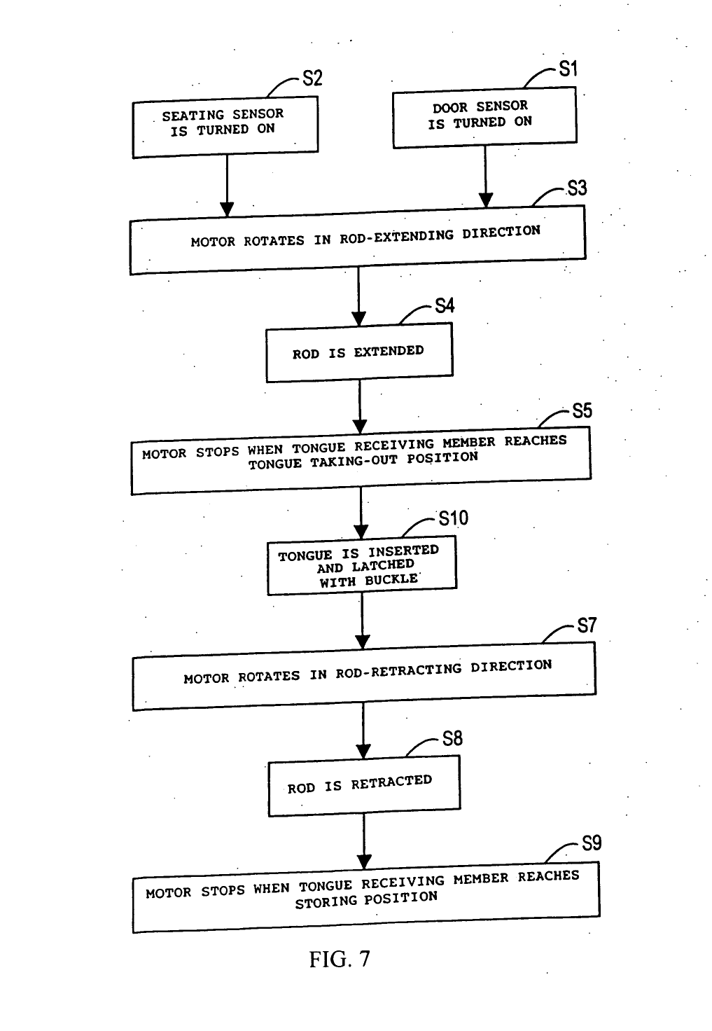

FIG. 7 is a flowchart showing another embodiment by which the motor drive of the tongue retrieval system may be controlled. In the embodiment previously described with respect to FIG. 6, the controller directs the motor 32 to rotate in the direction in which rod 17 is retracted when the tongue retrieval sensor 36 indicates that the tongue 5 has been retrieved from the tongue receiving member 18. In the tongue retrieval system of this embodiment, however, a conventional buckle switch (not shown) may be used instead of the tongue retrieval sensor 36. The buckle switch may output a tongue engagement signal upon detecting that the tongue 5 has been inserted and engaged with the buckle 6.

Similar to the embodiment previously described with respect to FIG. 6, in response to a door closing signal (from the door sensor) that indicates that the door is closed (Step S1) and a seating signal (from the seating sensor) that indicates that the occupant is seated (Step S2), the controller instructs the motor 32 to rotate in a direction in which the rod 17 is extended (Step S3). When the rod 17 is fully extended such that the tongue receiving member 18 reaches the tongue retrieval position 5″, as indicated by a full extension signal (from the rod full extension sensor), the motor 32 is stopped by the controller (Steps S4, S5). When the tongue 5, which is conveyed to the tongue retrieval position 5″ by the tongue receiving member 18, is retrieved by the occupant, as determined on the basis of the tongue engagement signal (from the buckle switch), the controller instructs the motor 32 to rotate in a reverse direction, i.e., in a direction in which the rod 17 is retracted (Steps S10, S7). Finally, when the rod 17 is fully retracted such that the tongue receiving member 18 reaches the plate storing position 19′, as indicated by a full retraction signal (from the rod retraction extension sensor), the motor 32 is stopped by the controller (Steps S8, S9).

In the tongue retrieval system in this embodiment, the tongue receiving member 18 is kept at the tongue retrieval position until the tongue 5 is inserted and engaged with the buckle 6. Accordingly, the tongue receiving member 18 is not returned to the plate storing position 19′ solely as a result of the tongue 5 being retrieved from the tongue receiving member 18, i.e., this embodiment essentially goes one step further than Step S6 in the embodiment shown in FIG. 6.

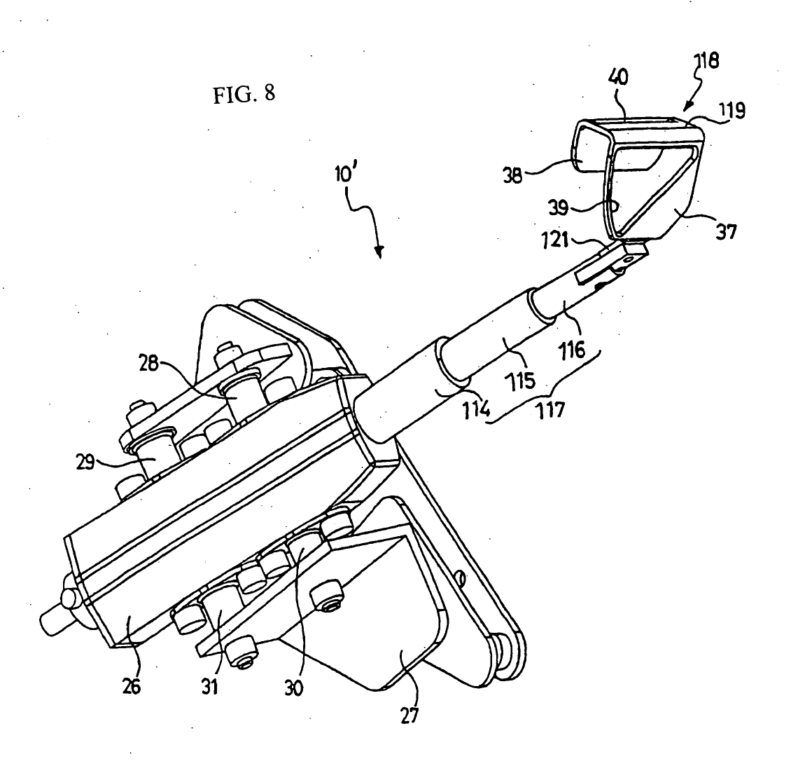

FIG. 8 is a perspective view that partially shows a tongue retrieval assisting device 10′ according to another embodiment of the present invention. In the embodiment previously described with respect to FIGS. 1A-5, the telescopically retractable rod 17 is composed of the four rod members 13-16. In contrast, in the tongue retrieval assisting device 10′ of the embodiment shown in FIG. 8, the rod 117 is composed of three telescoping rod members 114-116; the rod 114 that has the largest diameter, is however, similarly attached to the attaching bracket 26.

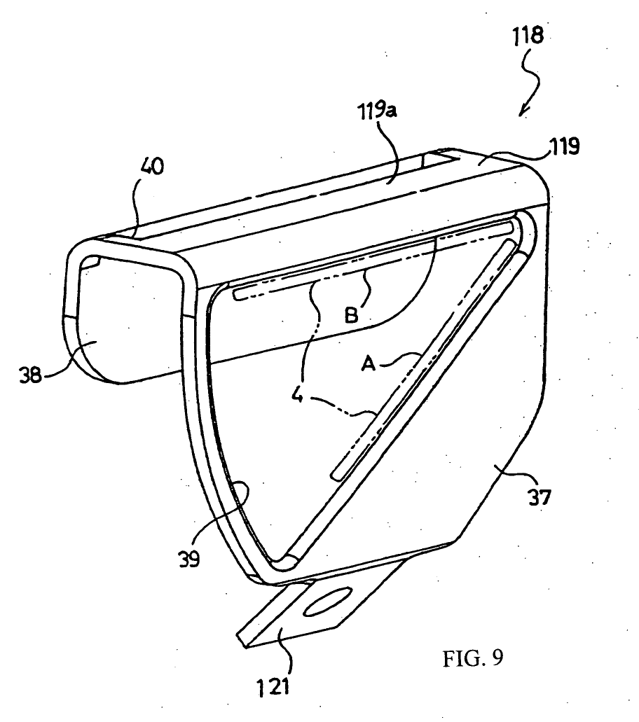

Further, in the previously described embodiment, as illustrated in FIGS. 3A-3C, the tongue receiving member 18 is provided with a tongue receiving plate 19 that has an approximately circular shape. However, as illustrated in FIG. 8, in the tongue retrieval assisting device 10′ of this embodiment, the tongue receiving member 118 of this embodiment has an approximately U-shaped cross-section one side of which serves as a tongue receiving plate 119. Specifically, the tongue receiving member 118 is composed of a long side wall 37, a short side wall 38, and the tongue receiving plate 119. The tongue receiving plate 119 has a flat and an approximately rectangular shape and that joins the side walls 37 and 38. Together, the tongue receiving plate 119 and the side walls 37, 38 form an approximately U-shape (in cross-section), as best illustrated in FIG. 9.

The long side wall 37 is provided with an attaching portion 121 at a lower part thereof. Similar to the previously described embodiment, the attaching portion 121 is attached to a tip end of the rod member 116 that has the smallest diameter. In addition, a penetration hole 39 is formed at the lower end of the long side wall 37. The penetration hole 39, which has a relatively large sectorial shape, is formed so that the seatbelt 4 is slidably provided therein.

When the tongue receiving member 118 is transferred from the plate storing position 19′ to the tongue retrieval position 5″, the portion of the seatbelt 4 in the penetration hole 39 moves from an orientation in which its face is inclined (shown by a mark A) to an orientation in which it is approximately horizontal (shown by mark B). On the other hand, when the tongue receiving member 118 is returned to the plate storing position 19′, the reverse happens, i.e., the portion of the seatbelt 4 in the penetration hole 39 moves from the horizontal orientation (mark B) to the inclined orientation (mark A). Moreover, when the tongue receiving member 118 is transferred, the inclination the seatbelt 4 is smoothly changed as a result of the penetration hole's 39 sectorial shape.

The width (i.e., the length in a belt-width direction) of the tongue receiving plate 119 that has a rectangular shape is smaller than the width (i.e., the length in a belt-width direction) of the gripping portion 22. Therefore, when the tongue receiving member 118 is at the tongue retrieval position 5″ and the gripping portion 22 of the tongue 5 is mounted on the tongue receiving plate 119, the left and right edges of the gripping portion 22 project outside of the left and right edges of the tongue receiving plate 119. As a result, similar to the previously described embodiment, when the occupant grips the gripping portion 22 of the tongue 5, the tongue receiving plate 119 is unlikely to be gripped together with the gripping portion 22.

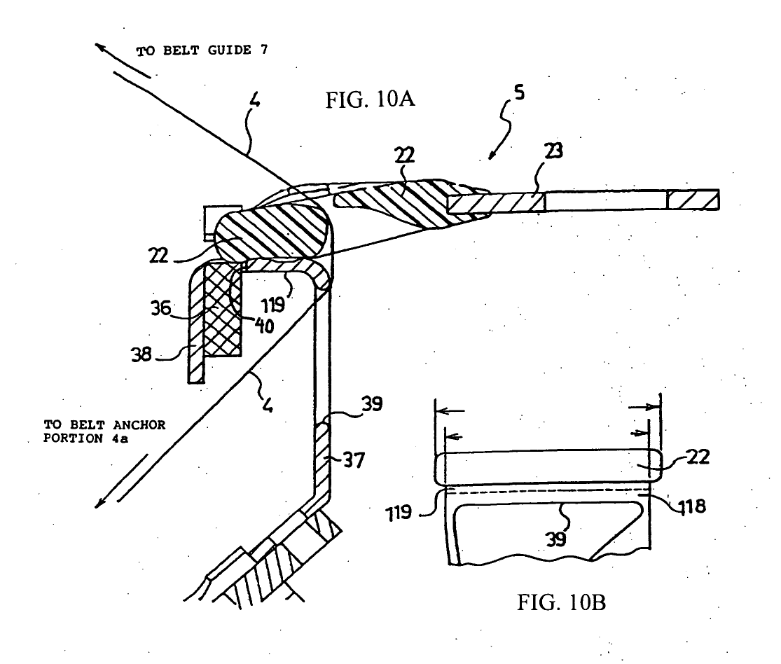

Furthermore, when the gripping portion 22 of the tongue 5 is mounted on the tongue receiving plate 119 (as shown in FIG. 10A), the gripping portion 22 is pressed to the relatively wide and flat tongue receiving face 119a of the tongue receiving plate 119 by the belt-retracting force of the seatbelt retractor 3. Accordingly, similar to the previously described embodiment, the gripping portion 22 is assuredly mounted onto the tongue receiving plate 119 and the tongue 5 is stably mounted onto the tongue receiving member 118.

The tongue receiving plate 119 of this embodiment includes a rectangular attaching hole 40. As illustrated in FIG. 10A, in the attaching hole 40, a tongue retrieval sensor 36 may be mounted. When the tongue receiving member 118 is in the tongue retrieval position 5″, if the tongue 5 is not retrieved by the occupant and remains mounted on the tongue receiving plate 119 of the tongue receiving member 118, the gripping portion 22 of the tongue 5 remains in contact with the tongue retrieval sensor 36 such that the tongue retrieval sensor 36 does not output the tongue retrieval signal. When the tongue 5 is retrieved by the occupant, the gripping portion 22 is released from the tongue retrieval sensor 36 and the tongue retrieval sensor 36 outputs the tongue retrieval signal.

In accordance with the tongue retrieval assisting device 10′ of this embodiment in which the tongue receiving plate 119 is formed into a rectangular shape, a gripping portion that has a rectangular shape, such as that of a conventional tongue, can be effectively mounted on a tongue receiving plate 119 by fitting with the rectangular shape of the tongue receiving plate 119. As a result, it is unnecessary to form the gripping portion 22 of the tongue 5 into a special shape and, therefore, the tongue receiving plate 119 is applicable to conventional tongues.

The other configurations and effects of this embodiment are the same as that of the previously described embodiment. In addition, the other configurations and effects of the seatbelt apparatus using the tongue retrieval assisting device 10′ of this embodiment are the same as that of the previously described embodiment.

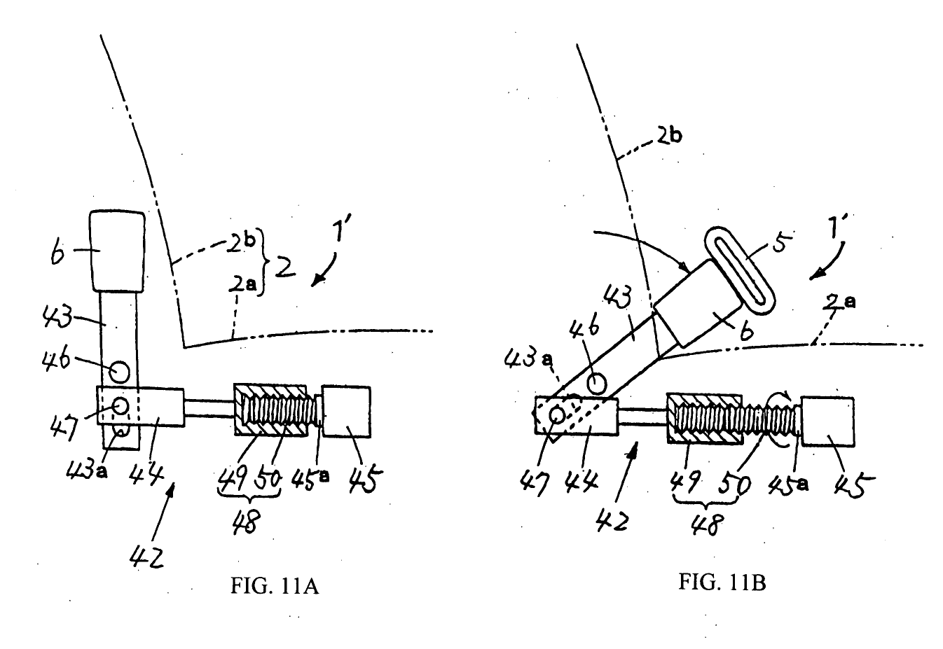

FIGS. 11A and 11B are illustrations that show still another embodiment of the present invention. FIG. 11A shows a buckle in a storing position and FIG. 11B shows the buckle in a using position;

Whereas the position of the buckle 6 is fixed in each of the previously described embodiments, as illustrated in FIGS. 11A and 11B in the seatbelt apparatus 1′ of this embodiment the buckle 6 may also be configured to move between a storing position (FIG. 11A) and a using position (FIG. 11B). A buckle device 42 includes: (a) a buckle 6; (b) a supporting lever 43 connected to the buckle 6; (c) a lever rotating member 44; and (d) a buckle drive device (e.g., a motor) 45 for driving the lever rotating member 44.

The supporting lever 43 is attached to the motor vehicle seat 2 or the body of the vehicle with a rotation shaft 46 such that the supporting lever 43 can rotate in a front-and-back direction of the motor vehicle. One end of the supporting lever 43, which is opposite the buckle 6, includes an elongated hole 43a that extends in a longitudinal direction. A connecting pin 47 is slidably provided in the elongated hole 43a such that the supporting lever 43 and the lever rotating member 44 are rotatably and movably connected with each other.

An end of the lever rotating member 44, which is opposite to the supporting lever 43, is connected to a rotation shaft 45a of the motor 45 by a screw-type retraction/extension mechanism 48. The screw-type retraction/extension mechanism 48 is composed of: (a) an internal thread member 49 that is fixed to the lever rotating member 44; and (b) an external thread member 50 that is formed on the rotation shaft 45a and is screwed together with the internal thread member 49. In addition, the external thread member 50 can also be formed separately from the rotation shaft 45a and connected to the rotation shaft 45a.

When the rotation shaft 45a of the motor 45 rotates and the external thread member 50 rotates in the same direction, the internal thread member 49 reversibly moves responsive to the rotational direction of the motor 45 in a left-and-right direction in FIGS. 11A and 11B. Thereby, the screw-type retraction/extension mechanism 48 retracts or extends. The motor 45 and the screw-type retraction/extension mechanism 48 are disposed inside the seat cushion 2a of the motor vehicle seat 2, or at a lower part of the seat cushion 2a.

As illustrated in FIG. 11A, when the buckle is not used, the screw-type retraction/extension mechanism 48 may be fully retracted such that the supporting lever 43 is forced to be approximately vertical, thereby positioning the buckle 6 in the storing position in the seatback 2b of the motor vehicle seat 2. In addition, as illustrated in FIG. 11B, when the buckle 6 is used, the screw-type retraction/extension mechanism 48 is fully extended such that the lever rotating member 44 rotates the supporting lever 43 around the rotation shaft 46 in a clockwise direction. When the supporting lever 43 is rotating: (a) the connecting pin 47 slides along the elongated hole 43a formed in the supporting lever 43; and (b) the buckle 6 passes through an inlet/outlet (not shown), which is formed in the seatback 2b of the motor vehicle seat 2, and advances to the using position at the side of the seat 2. Thereafter, the motor 45 is stopped and the buckle 6 is locked at the using position (by immobilizing the internal and external threads 49, 50).

The motor 45 of the buckle device 42 at the storing position may be driven by an electronic controller (not shown) in conjunction with the motor 32 of the tongue retrieval assisting device 10, 10′, when the motor 32 is driven by the electronic controller to move the tongue receiving plate 19, 119 from the plate storing position 19′ to the tongue retrieval position 5″. As a result, the tongue 5 may be conveyed to the tongue retrieval position 5″ and the buckle 6 may simultaneously be transferred to the using position. Accordingly, both the tongue retrieval assisting device 10, 10′ and the buckle 6 do not disturb the occupant when the seatbelt 4 is not used. Moreover, when the seatbelt 4 is used, the occupant is enabled to easily engage the tongue 5 and the buckle 6. Further, the buckle 6 may be returned to the storing position when, for example, the buckle switch turns off when the tongue 5 is released from the buckle 6, thereby instructing the motor 32 to transfer the buckle 6 from the using position to the storing position.

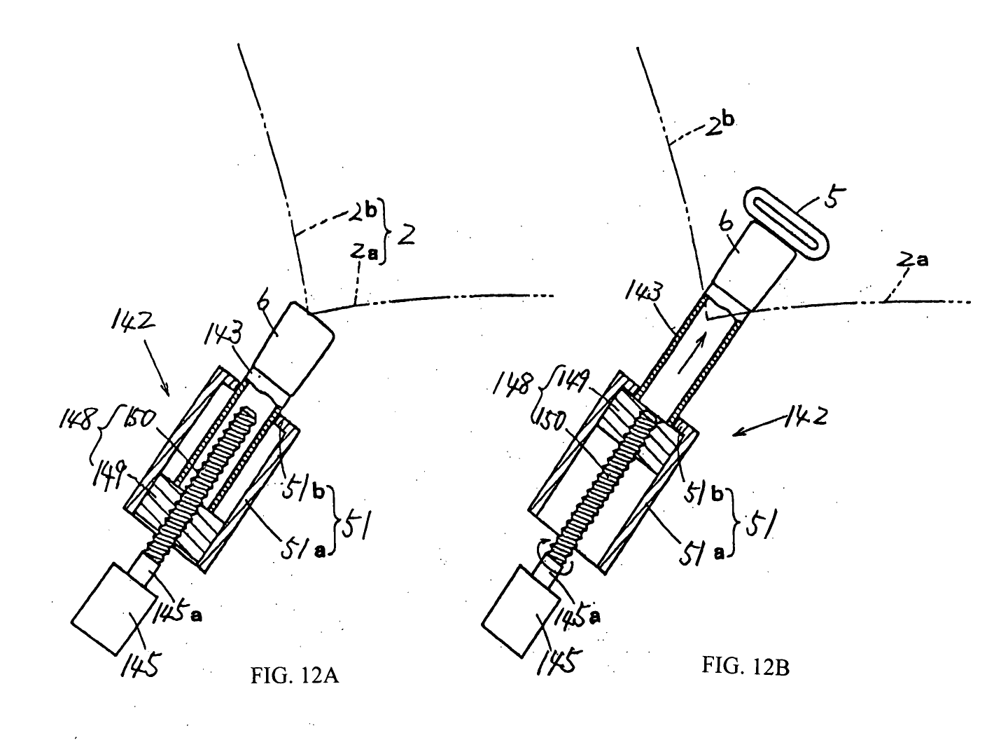

FIGS. 12A and 12B are illustrations that show still another embodiment of the present invention. FIG. 12A shows a buckle in a storing position and FIG. 12B shows the buckle in a using position.

In the embodiment illustrated in FIGS. 11A and 11B, the buckle 6 is selectively set to the storing position or the using position by the rotational movement of the supporting lever 43. However, in this embodiment as illustrated in FIGS. 12A and 12B, the buckle 6 is selectively set to the storing position or the using position by a linear movement of a supporting member 143.

As illustrated in FIGS. 12A and 12B, in the buckle device 142 of this embodiment, a screw-type retraction/extension mechanism 148 is composed of: (a) an internal thread member 149; and (b) an external thread member 150 that is formed on a rotation shaft 145a and is screwed with the internal thread member 149. The cylindrically shaped supporting lever 143, which supports the buckle 6, is connected to the internal thread member 149. The internal thread member 149 is provided in a cylindrically shaped guiding/limiting member 51 that is fixed to the motor vehicle seat 2 or the body of the vehicle. In this case, the guiding/limiting member 51 is provided with: (a) a guiding portion 51a to guide the internal thread member 149 in an axial direction (by preventing the internal thread member 149 from rotating); and (b) a transfer limitation portion 51b for limiting a movement of the buckle 6 in the axial direction between storing and using positions.

When the rotation shaft 145a of the motor 145 rotates and the external thread member 150 rotates in the same direction, the internal thread member 149 reversibly moves in the axial direction of the rotation shaft 145a. Thereby, the screw-type retraction/extension mechanism 148 retracts or extends. Consequently, the supporting lever 143 is advanced from the guiding/limiting member 151 or is accommodated therein.

Similar to the buckle device 42 of the previously described embodiment, in the buckle device 142 of this embodiment, the buckle 6 is concealed in the motor vehicle seat 2 in the storing position (FIG. 12A) and the buckle 6 is advanced from the storing position to the using position (FIG. 12B) at the side of the seat cushion 2a and the seatback 2b of the motor vehicle seat 2.

In contrast to the previously described buckle device 42, in the buckle device 142 of this embodiment, the supporting lever 143 performs a linear rather than a rotational movement. As a result, the movement of the supporting lever 143 is stable, and the storing position and the using position of the buckle 6 are further assuredly set. In this embodiment, when the buckle 6 is at the using position, the internal thread member 149 contacts the transfer limitation portion 51b, thereby limiting the movement of the buckle 6 in the direction in which the buckle 6 is advanced toward the using position.

Furthermore, when the occupant wears the seatbelt 4 by engaging the tongue 5 with the buckle 6 and when a tension force is applied to the buckle 6 through the seatbelt 4 and the tongue 5 (e.g., by a forward movement of the occupant due to inertia caused by a great deceleration of the motor vehicle), the force is assuredly received by the guiding/limiting member 51 through the supporting lever 143 and the internal thread member 149.

The other configurations and effects of the buckle device 142 of this embodiment are substantially the same as that shown in FIGS. 11A and 11B.

The tongue retrieval sensor 36 and/or the buckle switch for detecting the retrieval operation of the tongue 5, which are used in each of the previously described embodiments may not always be necessary, e.g., the rotation of the motor may be started by manual switching. However, in consideration of ease of handling the tongue 5 and the ease of wearing the seatbelt 4, it may be preferable to automatically transfer the tongue receiving member 18, 118 between the plate storing position 19′ and the tongue retrieval position 5″ as mentioned in each of the previously described embodiments.

Both the elongated penetration hole 20 (FIG. 3B) for slidably receiving the seatbelt 4 and the sectorial penetration hole 39 (FIG. 9) may, as shown, be formed as openings that have closed perimeters. However, when a part of these penetration holes 20, 39 has an inlet, the seatbelt 4 can be easily inserted through the inlet into these penetration holes 20, 39, thereby allowing easy insertion of the seatbelt 4 into the penetration holes 20, 39.

In the previously described embodiments, the tongue retrieval assisting device 10, 10′ is attached to the motor vehicle seat 2. However, the present invention is not limited to this configuration and the tongue retrieval assisting device 10, 10′ may be, e.g., provided in a floor portion of the body of the vehicle, or the like.

The priority application, Japanese Application No. 2004-322218, which was filed on Nov. 5, 2004, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure that are within the scope and spirit of the present invention are to be included as further embodiments of the present invention. The scope of the present invention is to be defined as set forth in the following claims.

What is claimed is:

1. A tongue retrieval system for conveying a tongue that is slidably supported by a seatbelt to a tongue retrieval position, which is in front of an occupant seated on a motor vehicle seat, the system comprising:
a tongue receiving member on which the tongue is mounted for conveying the tongue to the tongue retrieval position;
a transfer device for transferring the tongue receiving member between a tongue storing position and the tongue retrieval position;
a transfer device driver for driving the transfer device;
a controller for controlling the transfer device driver;
a seating sensor for detecting that the occupant is seated on the motor vehicle seat and for outputting a seating signal;
a door sensor for outputting a door-close signal when a door adjacent the seat of the motor vehicle is closed; and
a tongue retrieval sensor for outputting a tongue retrieval signal when the tongue is retrieved from the tongue receiving member,
wherein the controller is configured to control the transfer device driver such that the transfer device transfers the tongue from:
(a) the tongue storing position to the tongue retrieval position on a basis of the seating signal from the seating sensor and the door-close signal from the door sensor; and
(b) the tongue retrieval position to the tongue storing position on the basis of the tongue retrieval signal from the tongue retrieval sensor.

2. A tongue retrieval system for conveying a tongue that is slidably supported by a seatbelt to a tongue retrieval position, which is in front of an occupant seated on a motor vehicle seat, the system comprising:
a tongue receiving member on which the tongue is mounted for conveying the tongue to the tongue retrieval position;
a transfer device for transferring the tongue receiving member between a tongue storing position and the tongue retrieval position;
a transfer device driver for driving the transfer device;
a controller for controlling the transfer device driver;
a seating sensor for detecting that the occupant is seated on the motor vehicle seat and for outputting a seating signal;
a door sensor for outputting a door-close signal when a door adjacent the seat of the motor vehicle is closed;
a buckle, which is mounted on the motor vehicle and which is configured to engage the tongue; and
a buckle switch for outputting a tongue engagement signal when the tongue is engaged with a buckle,
wherein the controller is configured to control the transfer device driver such that the transfer device transfers the tongue from:
(a) the tongue storing position to the tongue retrieval position on a basis of the seating signal from the seating sensor and the door-close signal from the door sensor; and
(b) the tongue retrieval position to the tongue storing position on the basis of the tongue engagement signal from the buckle switch.

3. A seatbelt apparatus comprising:
a seatbelt for restraining an occupant in a motor vehicle seat;
a seatbelt retractor mounted on the motor vehicle for constantly urging the seatbelt in a retracting direction;
a tongue that is slidably supported by the seatbelt;
a buckle, which is mounted on the motor vehicle and which is configured to engage the tongue; and
a tongue retrieval system for conveying the tongue to a tongue retrieval position, which is in front of the occupant seated on the motor vehicle seat, the system comprising:
a tongue receiving member on which the tongue is mounted for conveying the tongue to the tongue retrieval position;
a transfer device for transferring the tongue receiving member between a tongue storing position and the tongue retrieval position;
a transfer device driver for driving the transfer device;
a controller for controlling the transfer device driver;
a seating sensor for detecting that the occupant is seated on the motor vehicle seat and for outputting a seating signal;
a door sensor for outputting a door-close signal when a door adjacent the seat of the motor vehicle is closed; and
a tongue retrieval sensor for outputting a tongue retrieval signal when the tongue is retrieved from the tongue receiving member,
wherein the controller is configured to control the transfer device driver such that the transfer device transfers the tongue from:
(a) the tongue storing position to the tongue retrieval position on a basis of the seating signal from the seating sensor and the door-close signal from the door sensor; and
(b) the tongue retrieval position to the tongue storing position on the basis of the tongue retrieval signal from the tongue retrieval sensor.

4. A seatbelt apparatus comprising:
a seatbelt for restraining an occupant in a motor vehicle seat;
a seatbelt retractor mounted on the motor vehicle for constantly urging the seatbelt in a retracting direction;
a tongue that is slidably supported by the seatbelt;
a buckle, which is mounted on the motor vehicle and which is configured to engage the tongue; and
a tongue retrieval system for conveying the tongue to a tongue retrieval position, which is in front of the occupant seated on the motor vehicle seat, the system comprising:
a tongue receiving member on which the tongue is mounted for conveying the tongue to the tongue retrieval position;
a transfer device for transferring the tongue receiving member between a tongue storing position and the tongue retrieval position;
a transfer device driver for driving the transfer device;
a controller for controlling the transfer device driver;
a seating sensor for detecting that the occupant is seated on the motor vehicle seat and for outputting a seating signal;
a door sensor for outputting a door-close signal when a door adjacent the seat of the motor vehicle is closed; and
a buckle switch for outputting a tongue engagement signal when the tongue is engaged with the buckle,
wherein the controller is configured to control the transfer device driver such that the transfer device transfers the tongue from:
(a) the tongue storing position to the tongue retrieval position on a basis of the seating signal from the seating sensor and the door-close signal from the door sensor; and
(b) the tongue retrieval position to the tongue storing position on the basis of the tongue engagement signal from the buckle switch.

5. The seatbelt apparatus according to claim 3, further comprising:
a buckle transfer device for transferring the buckle between a buckle storing position and a buckle using position in which the buckle is engaged with the tongue by the occupant;
a buckle driver for driving the buckle transfer device; and
a controller for controlling the buckle driver such that the buckle is transferred from the buckle storing position to the buckle using position in conjunction with the driving operation of the transfer device driver.

6. The seatbelt apparatus according to claim 5, wherein the buckle is configured to move from the buckle storing position to the buckle using position along an arcuate path.

7. The seatbelt apparatus according to claim 5, wherein the buckle is configured to move from the buckle storing position to the buckle using position along a linear path.

8. The seatbelt apparatus according to claim 4, further comprising:
a buckle transfer device for transferring the buckle between a buckle storing position and a buckle using position in which the buckle is engaged with the tongue by the occupant;
a buckle driver for driving the buckle transfer device; and
a controller for controlling the buckle driver such that the buckle is transferred from the buckle storing position to the buckle using position in conjunction with the driving operation of the transfer device driver.

9. The seatbelt apparatus according to claim 8, wherein the buckle is configured to move from the buckle storing position to the buckle using position along an arcuate path.

10. The seatbelt apparatus according to claim 8, wherein the buckle is configured to move from the buckle storing position to the buckle using position along a linear path.

11. A system for conveying a tongue that is slidably supported by a seatbelt to a retrieval position in front of an occupant seated on a motor vehicle seat, the system comprising:
a tongue receiving member on which the tongue is mounted;
a driven transfer device for transferring the tongue receiving member between a storage position and the retrieval position;
a first sensor for detecting that the occupant is seated on the seat;
a second sensor for detecting when a door adjacent the seat is closed;
a third sensor for detecting when the tongue is retrieved from the tongue receiving member; and
a controller configured to control the movement of the transfer device from the storage position to the retrieval position based on input from the first and second sensors, and from the retrieval position to the storage position based on input from the third sensor.
